(19) United States
(12) Patent Application Publication
(10) Pub. No.: US 2016/0061438 A1
(43) Pub. Date: Mar. 3, 2016

(54) LAMP DEVICE WITH CENTRAL INTELLIGENCE INTEGRATED SPEAKER

(71) Applicant: illuminati Enterprise Co., Ltd., Taoyuan (TW)

(72) Inventor: Yu-Hsiu Lu, Taoyuan (TW)

(21) Appl. No.: 14/600,096

(22) Filed: Jan. 20, 2015

(30) Foreign Application Priority Data
Aug. 27, 2014 (TW) 103215287

(51) Int. Cl. F21V 33/00; H05B 37/02; F21V 3/04; H04R 1/02; F21V 29/77

(52) U.S. Cl. CPC F21V 33/0056; H04R 1/028; F21V 29/777; F21V 3/04; H05B 37/0272; H04R 2420/07; H04R 2430/01; F21Y 2101/02

(57) ABSTRACT

A lamp device with a central intelligence integrated speaker at least includes a rear housing, a front housing, a speaker, a light emitting module, a transmission module and a control processing module. The speaker and the light emitting module are disposed between the front housing and the rear housing. The transmission module is adapted to be identified by an electronic device. When the electronic device identifies the transmission module and establishes a matching connection with the transmission module according to a connection signal, the electronic device transmits a control instruction to the control processing module through the transmission module via a wireless means. The speaker and/or the light emitting module is activated according to the control instruction to cause the light emitting module to emit a light source and to cause the speaker to output an audio source played by the electronic device.

### BACKGROUND OF THE INVENTION

a) Field of the Invention

The invention relates in general to a lamp device, and more particularly, to a lamp device with a central intelligence integrated speaker.

b) Description of the Prior Art

Lighting devices are indispensible home appliances in the daily lives. With the progressing technologies and living standard, people correspondingly demand higher requirements of lighting devices. To satisfy people's requirements on lighting devices, various quality light devices have been developed.

Sound amplifiers, or simply referred to as speakers, are a type of apparatus that converts electronic signals into sounds, and are common in the daily lives. The nature of a speaker determines the quality of sound output. Thus, in order satisfy consumers with high demands on the sound output quality of speakers developed, associated manufacturers continue in improving their products.

Although current lighting devices and speakers are constantly improving, either of these devices supports a single function of lighting or sound output. When a user wishes to use the lighting function and the speaker function at the same time, not only a lighting device and a speaker as two independent objects need to be purchased and installed, but respective controllers also need to be used in order to control the lighting device and the speaker, leading to inconveniences in space planning and configuration, installation as well as application.

### SUMMARY OF THE INVENTION

In view of the issues of the prior art, it is an object of the present invention to provide a lamp device with a central intelligence integrated speaker, which integrates speaker and lighting functions and can be centrally controlled by a same wireless controller.

A lamp device with a central intelligence integrated speaker provided by the present invention includes: a rear housing, having an opening; a front housing, fixedly installed at the opening of the rear housing, an accommodating space formed between the front housing and the rear housing, a lamp cave formed by recessing a center of the front housing towards the rear housing, a plurality of sound holes formed at a surface of the front housing near a periphery of the lamp cave; a speaker, disposed in the accommodating space; a light emitting module, disposed in the lamp cave, being in thermal contact with a surface of the lamp cave; a transmission module, configured to transmit a connection signal to be identified by an electronic device, the electronic device transmitting a control instruction via a wireless means to the transmission module upon identifying the transmission module and establishing a matching connection with the transmission module according to the connection signal; and a control processing module, electrically connected to the speaker, the light emitting module and the transmission module, configured to receive the control instruction from the transmission module, and to activate the speaker and/or the light emitting module to cause the light emitting module to emit a corresponding light source and to cause the speaker to output an audio source played by the electronic device.

To achieve the object of the present invention, a lamp device with a central intelligence integrated speaker further provided by the present invention includes: a rear housing, having an opening; a front housing, fixedly installed at the opening of the rear housing, an accommodating space formed between the front housing and the rear housing, a lamp cave formed by recessing a center of the front housing towards the rear housing, a plurality of sound holes formed at a surface of the front housing near a periphery of the lamp cave, a plurality of heat dissipation ribs formed on a surface of one side of the lamp cave corresponding to the rear housing, an optical diffusion plate provided in the lamp cave, a periphery of the optical diffusion plate fastened to an inner wall of the lamp cave; two fixing assemblies, disposed opposite each other on an outer wall of the rear housing, each of the fixing assemblies including a two metal plate pivotally installed to each other and a spring, the spring provided at a pivotal joint of the two metal plates, one of the metal plates fixedly mounted on the outer wall of the rear housing; a speaker, installed in the accommodating space; a light emitting module, a plurality of light emitting diodes provided on a substrate, the light emitting module installed in the lamp cave and being in thermal contact with the surface of the lamp cave and covered under the optical diffusion plate; a transmission module, configured to transmit a connection signal to be identified by an electronic device, the electronic device transmitting a control instruction to the transmission module via a wireless means upon identifying the transmission module and establishing a matching connection with the transmission module according to the connection signal; and a control processing module, electrically connected to the speaker, the light emitting module and the transmission module, configured to receive the control instruction from the transmission module, and to activate the speaker and/or the light emitting module to cause the light emitting module to emit a corresponding light source and to cause the speaker to output an audio source played by the electronic device.

As described, the lamp device with a central intelligence integrated speaker of the present invention integrates speaker and lighting functions into one device. A user is allowed to control the lamp device at a remote end by wireless means through a device such as a cell phone or a computer with a wireless transmission function such as WiFi and Bluetooth, so as to cause the lamp device to send out corresponding lighting effects and musical sounds, thereby offering the user with optimal ease of use as the user watches a movie or listens to music.

Further, in one application of the lamp device with a central intelligence integrated speaker, with an additional multi-channel/surround sound configuration, the lamp device may be installed in a living room, study, bedroom and/or audiovisual entertainment room and be connected to a home television and a projector via a wireless control system to provide a video broadcasting function. In another application, the lamp device may be further connected to an existing home multimedia player. Thus, the lamp device with a central intelligence integrated speaker achieves integrated home multimedia broadcasting.

Further, for any consumer device with a wireless communication function, e.g., WiFi, songs, movies or filmed videos in the consumer device may be played through the lamp device with a central intelligence integrated speaker to provide an immediate wireless audiovisual function. In the current era of the increasing network speed, video online rental or video online purchase services are offered by many cell phone system manufacturers. By directly using a consumer device such as a cell phone, wireless playback can be achieved without involving complications of connections to a television with an additional video transmission line.

Further, a home wireless network may also be connected to the lamp device with a central intelligence integrated speaker. Thus, using a control program, any home computer within the wireless network may easily play a video in the computer or select a song to be played by the lamp device with a central intelligence integrated speaker, hence eliminating the time and effort of looking for a portable USB disk or burning a compact disk. Meanwhile, with consumer electronic device control software, lighting effects as well as the volume of the lamp device with a central intelligence integrated speaker can be adjusted to yield an enjoyable atmosphere for moving watching.

### BRIEF DESCRIPTION OF THE DRAWINGS

FIG. 1 is a first schematic diagram of a lamp device with a central intelligence integrated speaker of the present invention;

FIG. 2 is a second schematic diagram of a lamp device with a central intelligence integrated speaker of the present invention;

FIG. 3 is a third schematic diagram of a lamp device with a central intelligence integrated speaker of the present invention;

FIG. 4 is a fourth schematic diagram of a lamp device with a central intelligence integrated speaker of the present invention;

FIG. 5 is a block diagram of a lamp device with a central intelligence integrated speaker of the present invention; and

FIG. 6 is a schematic diagram of a lamp device with a central intelligence integrated speaker according to an embodiment of the present invention.

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings. It should be noted that, these drawings are for illustrating and explaining the application, and may be not be drawn to actual sizes and precise ratios. Therefore, the ratios and configurations of the drawings are not to be construed as limitations to the present invention, and the scope of the present invention is to be accorded with the appended claims.

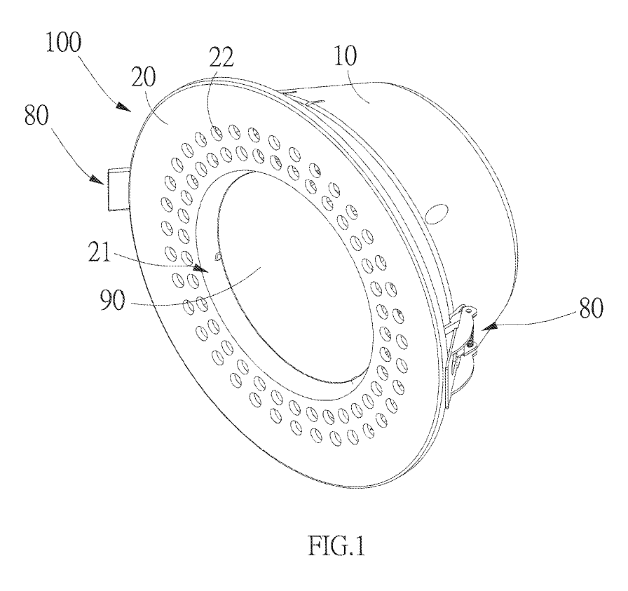

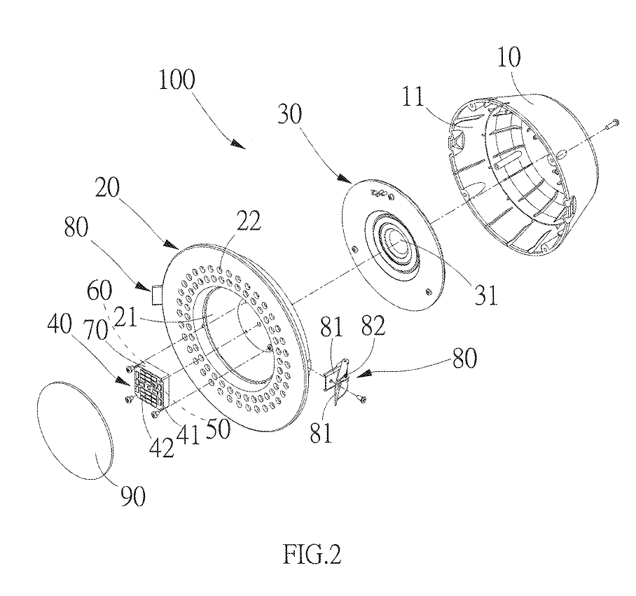

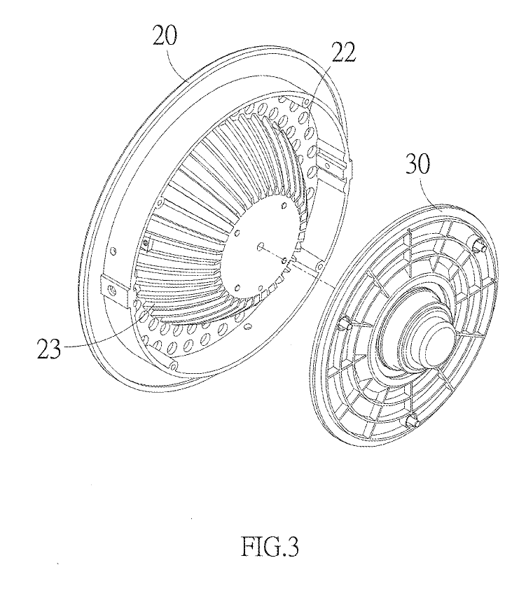

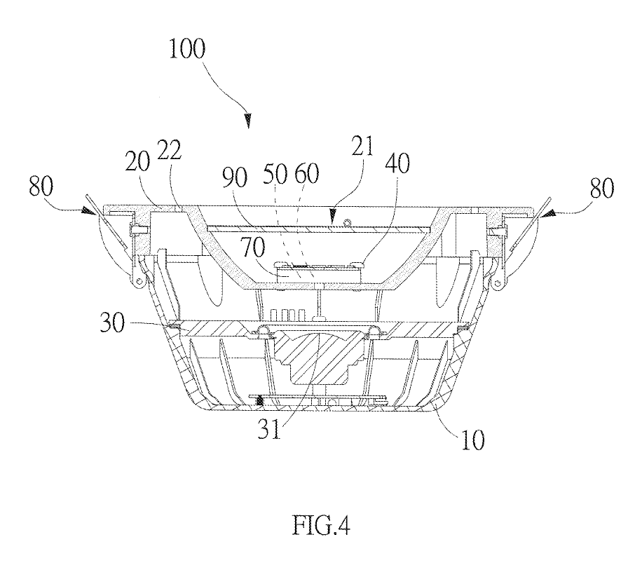

FIG. 1 to FIG. 5 are a first schematic diagram, a second schematic diagram, a third schematic diagram, a fourth schematic diagram and a block diagram of a lamp device with a central intelligence integrated speaker, respectively. The lamp device with a central intelligence integrated speaker 100 includes a rear housing 10, a front housing 20, a speaker 30, a light emitting module 40, a transmission module 50, a control processing module 60, a power module 70, fixing assemblies 80 and an optical diffusion plate 90.

Structurally, the rear housing 10 is a circular dish-like housing and has an opening 11. The front housing 20 is fixedly installed at the opening 11 of the rear housing 10. Between the front housing 20 and the rear housing 10 is an accommodating space adapted to accommodate the speaker 30. A center of the front housing 20 is recessed towards the rear housing 10 to form a lamp cave 21, which is may accommodate and is in thermal contact with the light emitting module 40. Further, the accommodating space may accommodate the transmission module 50, the control processing module 60 and the power module 70. At a surface of the front housing 20 near a periphery of the lamp cave 21, a plurality of sound holes 22 are formed to directly transport sounds from the speaker 30 out of the accommodating space. On a surface of one side of the lamp cave 21 of the front housing 20 corresponding to the rear housing 10, a plurality of heat dissipation ribs 23 are formed. In a preferred configuration, two ends of each of the heat dissipation ribs 23 extend towards the front housing 20 and the rear housing 10, respectively, and the heat dissipation ribs 23 are arranged side by side to one another. As such, a surface area of the one side of the lamp cave 21 corresponding to the rear housing 10 can be increased to enhance the heat dissipation efficiency of the lamp cave 21.

Further, the fixing assemblies 80 are disposed facing each other on an outer wall of the rear housing 10, each of the fixing assemblies 80 includes two metal plates 81 pivotally installed to each other and a spring 82. The spring 82 is disposed at the pivotal joint of the two metal plates 81 to provide an elastic force between the two metal plates 81. In one preferred configuration, a contractible elastic force is present between the two metal plates 81, and one of the metal plates 81 is fixed to the outer wall of the rear housing 10 by an element such as a rivet. As such, using the contractible elastic force between the two metal plates 81, the metal plate 81 that is not fixed to the rear housing 10 can be fastened to an inner surface of a ceiling or a wall. Further, the optical diffusion plate 90 is provided in the lamp cave 21 of the front housing 20. The optical diffusion plate 90 has a periphery fastened at the inner wall of the lamp cave 21, and covers above the light emitting module 40. The optical diffusion plate 90 allows the light intensity from the light emitting module 40 to be evenly distributed to reduce brightness differences within a space.

In the above, the speaker 30 includes a drumhead 31. After receiving an electric signal, the speaker 30 converts electrical energy of the electric signal to mechanical energy to vibrate the drumhead 31. Nearby air particles are vibrated by the drumhead 31 to produce musical sounds, which are then transported out of the accommodating space via the plurality of sound holes 22 provided on the front housing 20.

In the above, the light emitting module 40 is fixedly installed and is in thermal contact with the surface of the lamp cave 21 of the front housing 20 by a plurality of screws. Thus, high-temperature heat energy produced as the light emitting module 40 emits light is transmitted to the plurality of heat dissipation ribs 23 on the surface of one side of lamp cave 21 corresponding to the rear housing 10 to reduce the highest temperature of the light emitting module 40. Meanwhile, the heat energy is dissipated via the plurality of sound holes 22 on the front housing 20 to further ensure and prolong the lifecycle of the light emitting module 40. The light emitting module 40 mainly includes a substrate 41 and a plurality of light emitting diodes 42. The light emitting diodes 42 are disposed on the substrate 41, and are connected to one another via lines on the substrate 41.

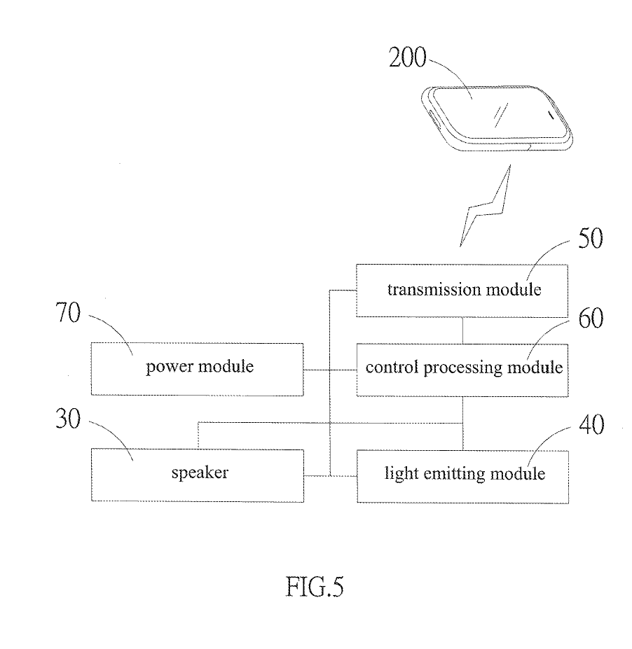

From a system aspect, as shown in FIG. 5, the control processing module 60 is electrically connected to the speaker 30, the light emitting module 40, the transmission module 50 and the power module 70, and the power module 70 is electrically connected to the transmission module 50. For example, the power module 70 is a small power supply device such as a battery. When the lamp device 100 is not connected to city electricity, the power module 70 may provide the transmission module 50 and the control processing module 60 with power required for operations. For example, the transmission module 50 may be a wireless transmission device such as Bluetooth or WiFi wireless transmission device, and is adapted to actively send a connection signal to be identified by an electronic device 200. When the electronic device 200 identifies the transmission module 50 and establishes a matching connection with the transmission module 50 according to the connection signal, the electronic device 200 may transmit a control instruction to the transmission module 50 via wireless means. For example, the electronic device 200 may be a device with a wireless transmission function, e.g., a smart phone, a computer or a smart television. For example, the control processing module 60 is a microprocessor, which independently activates the speaker 30 or the light emitting module 40 according to the control instruction, or simultaneously activates the speaker 30 and the light emitting module 40 according to the control instruction, to cause the light emitting module 40 to emit a corresponding light source and to cause the speaker 30 to output an audio source played by the electronic device 200. The electronic device 200 has a control program that can be operated by a user to send out a wireless control instruction, so as to allow the user to adjust the volume of the speaker 30 as well as the color temperature and the brightness of the light emitting module 40 through the control processing module 60.

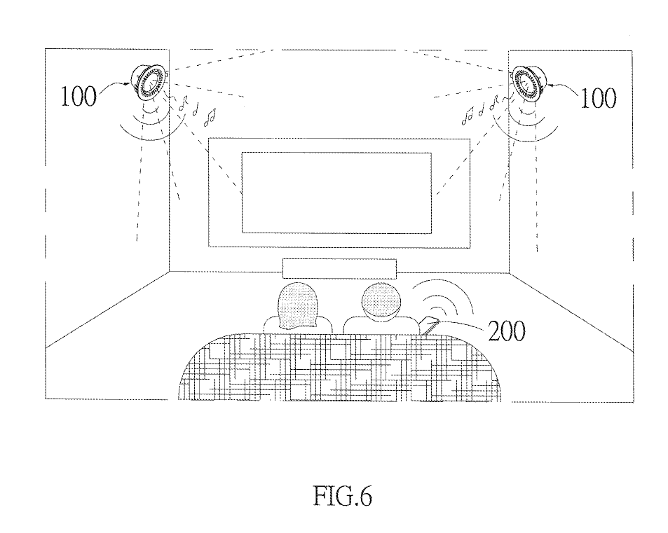

FIG. 6 shows a schematic diagram of a lamp device with a central intelligence integrated speaker according to an embodiment of the present invention. In practice, a user may install the lamp device with a central intelligence integrated speaker at home. To use the lamp device 100 for lighting or music playback, the electronic device 200 such as a cell phone or a computer may be used to perform wireless control. The electronic device 200 is capable of simultaneously controlling multiple lamp devices 100 installed. For example, when the user wishes to listen to music played by the electronic device 200 through a device with a speaker function, using a wireless control instruction sent by the electronic device 200 to the lamp device 100, the lamp device 100 is caused to output the audio source currently played by the electronic device 200, while the output volume of the lamp device 100 is concurrently adjustable by the user as desired. When the user wishes to watch a movie through the electronic device 200 or a television, the user may wirelessly control the lamp device 100 using the electronic device 200 to cause the lamp device 100 to output corresponding sounds of the video. Further, the user can also adjust the light source emitted from the lamp device 100, including the color temperature and the brightness, so as to achieve optimal audio and lighting effects for viewing the video.

In conclusion, the lamp device with a central intelligence integrated speaker of the present invention integrates speaker and lighting functions into one device. Thus, without involving additional installation or individual control, a user may wirelessly remote control the lamp device using a device such as a cell phone or a computer having a WiFi or Bluetooth wireless transmission function to cause the lamp device to send out corresponding lighting and musical sounds, thereby providing ideal practicability and convenience.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lamp device with a central intelligence integrated speaker, comprising:
a rear housing, having an opening;
a front housing, fixedly installed at the opening of the rear housing, an accommodating space formed between the front housing and the rear housing, a lamp cave formed by recessing a center of the front housing towards the rear housing, a plurality of sound holes formed at a surface of the front housing near a periphery of the lamp cave;
a speaker, disposed in the accommodating space;
a light emitting module, disposed in the lamp cave, being in thermal contact with a surface of the lamp cave;
a transmission module, configured to transmit a connection signal to be identified by an electronic device, the electronic device transmitting a control instruction via a wireless means to the transmission module upon identifying the transmission module and establishing a matching connection with the transmission module according to the connection signal; and
a control processing module, electrically connected to the speaker, the light emitting module and the transmission module, configured to receive the control instruction from the transmission module, and to activate the speaker and/or the light emitting module to cause the light emitting module to emit a corresponding light source and to cause the speaker to output an audio source played by the electronic device.

2. The lamp device with a central intelligence integrated speaker according to claim 1, wherein the transmission module wirelessly connects to the electronic device via Bluetooth or WiFi.

3. The lamp device with a central intelligence integrated speaker according to claim 1, wherein the electronic device has a control program for a user to operate, and the wirelessly transmitted control instruction is capable of adjusting a volume of the speaker and a color temperature and brightness of the light emitting module through the control processing module.

4. The lamp device with a central intelligence integrated speaker according to claim 1, wherein the electronic device is a smart phone, a computer or a smart television.

5. The lamp device with a central intelligence integrated speaker according to claim 1, wherein the light emitting module is provided with a plurality of light emitting diodes on a substrate.

6. The lamp device with a central intelligence integrated speaker according to claim 1, wherein a plurality of heat dissipation ribs are formed on a surface of one side of the lamp cave of the front housing corresponding to the rear housing.

7. The lamp device with a central intelligence integrated speaker according to claim 6, wherein two ends of each of the heat dissipation ribs extend towards the front housing and the rear housing, respectively, and the plurality of heat dissipation ribs are arranged side by side to one another.

8. The lamp device with a central intelligence integrated speaker according to claim 1, further comprising two fixing assemblies disposed opposite each other on an outer wall of the rear housing.

9. The lamp device with a central intelligence integrated speaker according to claim 8, wherein each of the fixing assemblies comprises two metal plates pivotally installed to each other and a spring, the spring is provided at a pivotal joint of the two metal plates, and one of the metal plates is fixedly mounted on the outer wall of the rear housing.

10. The lamp device with a central intelligence integrated speaker according to claim 1, wherein an optical diffusion plate is further provided in the lamp cave, and the optical diffusion plate has a periphery fastened at an inner wall of the lamp cave and covers above the light emitting module.

11. The lamp device with a central intelligence integrated speaker according to claim 1, wherein the speaker comprises a drumhead.

12. The lamp device with a central intelligence integrated speaker according to claim 1, wherein the light emitting module is fixedly installed by a plurality of screws and is in thermal contact with a surface of the lamp cave.

13. A lamp device with a central intelligence integrated speaker, comprising:
a rear housing, having an opening;
a front housing, fixedly installed at the opening of the rear housing, an accommodating space formed between the front housing and the rear housing, a lamp cave formed by recessing a center of the front housing towards the rear housing, a plurality of sound holes formed at a surface of the front housing near a periphery of the lamp cave, a plurality of heat dissipation ribs formed on a surface of one side of the lamp cave corresponding to the rear housing, an optical diffusion plate further provided in the lamp cave and having a periphery fastened to an inner wall of the lamp cave;
two fixing assemblies, disposed opposite each other on an outer wall of the rear housing, each of the fixing assemblies comprising two metal plates pivotally installed to each other and a spring, the spring provided at the pivotal joint of the two metal plates, one of the metal plates fixedly mounted on the outer wall of the rear housing;
a speaker, disposed in the accommodating space;
a light emitting module, a plurality of light emitting diodes provided on a substrate, the light emitting module installed in the lamp cave and being in thermal contact with the surface of the lamp cave and covered under the optical diffusion plate;
a transmission module, configured to transmit a connection signal to be identified by an electronic device, the electronic device transmitting a control instruction via a wireless means to the transmission module upon identifying the transmission module and establishing a matching connection with the transmission module according to the connection signal; and
a control processing module, electrically connected to the speaker, the light emitting module and the transmission module, configured to receive the control instruction from the transmission module, and to activate the speaker and/or the light emitting module to cause the light emitting module to emit a corresponding light source and to cause the speaker to output an audio source played by the electronic device.
